(19) United States
(12) Patent Application Publication
(10) Pub. No.: US 2002/0019861 A1
(43) Pub. Date: Feb. 14, 2002

(54) Method of communication used IP address by means of to fix a directory of IP address, even if IP address is not fixed in the network

(76) Inventor: Hiroyuki Sakamoto, Chigasaki-City (JP)

Correspondence Address: Hiroyuki Sakamoto, No.403, 6-31, Hamatake 4 chome, Chigasaki, 253-0021, JP

(21) Appl. No.: 09/892,692

(22) Filed: Jun. 26, 2001

(30) Foreign Application Priority Data
Jun. 29, 2000 (JP) 2000-236274

(51) Int. Cl. G06F 15/177

(52) U.S. Cl. 709/220

(57) ABSTRACT

The point of program that used this invention, even if IP address is not fixed be caused by to receive indefinite IP address from DHCP(Dynamic Host Configuration Protocol) server, be able to communicate by means of this program can get the IP address of other computer and give the own IP address, by means of this program store the file included IP address on the fixed directory path when connecting with network.

### CROSS-REFERRENCE TO RELATED APPLICATION

Not Applicable

### STATEMENT REGARDING FEDERALLY SPONSORED RESEARCH OR DEVELOPMENT

Not Applicable

### REFERENCE TO A MICROFICHE APPENDIX

Not Applicable

### BACKGROUND OF THE DISCLOSURE

1. Field of the Invention

The invention relates to method of peer to peer comunication in computer network using IP(Internet Protocol) address.

2.Description of the Prior Art

Operating the chat server, geme server or other lobby server, and when the computer comunicate with other computer via network by means of using IP address, the computer access a pertinent server.

This server receive the packet data from one computer and transmit other computer.

This way has problem, require high cost and labor for operating servers always.

Other way, get the IP address of remote computer by means of casting the packet data to refer IP address.

This way has probrem, increase the traffic of packet data.

### BRIEF SUMMARY OF THE INVENTION

The point of program that used this invention, even if IP address is not fixed be caused by to receive indefinite IP address from DHCP(Dynamic Host Configuration Protocol) server, be able to communicate by means of this program can get the IP address of other computer and give the own IP address, by means of this program store the file included IP address on the fixed directory path when connecting with network.

Previously, register the directory path name of IP FILE in the file of DIRECTORY PATH LIST, and store the DIRECTORY PATH LIST in the fixed directory path on the storage device.

IP FILE is a file, that includes a IP address of computer, running this program.

DIRECTORY PATH LIST is a file, that includes directory path name, each computer store the IP FILE, running this program.

IP FILE and DIRECTORY PATH LIST are permitted to read for other computer via network.

Input the file name of IP FILE and DIRECTORY PATH LIST to this program.

Input the directory path name of DIRECTORY PATH LIST on the strage device to this program.

The program that used this invention, store the IP FILE included own IP address on same directory path registered for own in the DIRECTORY PATH LIST on the storage device when connect with network every time.

This program is able to get IP address other computer that connecting with network by means of to read IP FILE for other computer from directory path on the strage device, that directory path name is registered DIRECTORY PATH LIST.

Finally, even if the computer receive indefinite IP address from DHCP server, be able to communicate with other computer via network without lobby server.

### BRIEF DESCRIPTION OF THE DRAWINGS

FIG. 1 case of internet, run the program using this invention on the computer(1,2), and computer(1,2) can connect with internet via each provider;

FIG. 2 example of DIRECTORY PATH LIST that include URL(Universal Resource Locator) and directory(42,52) where each computer(1,2) store the IP FILE(41,51);

FIG. 3 example of IP FILE that include global IP address of the computer connecting with internet;

FIG. 4 program flow chart using this invention.

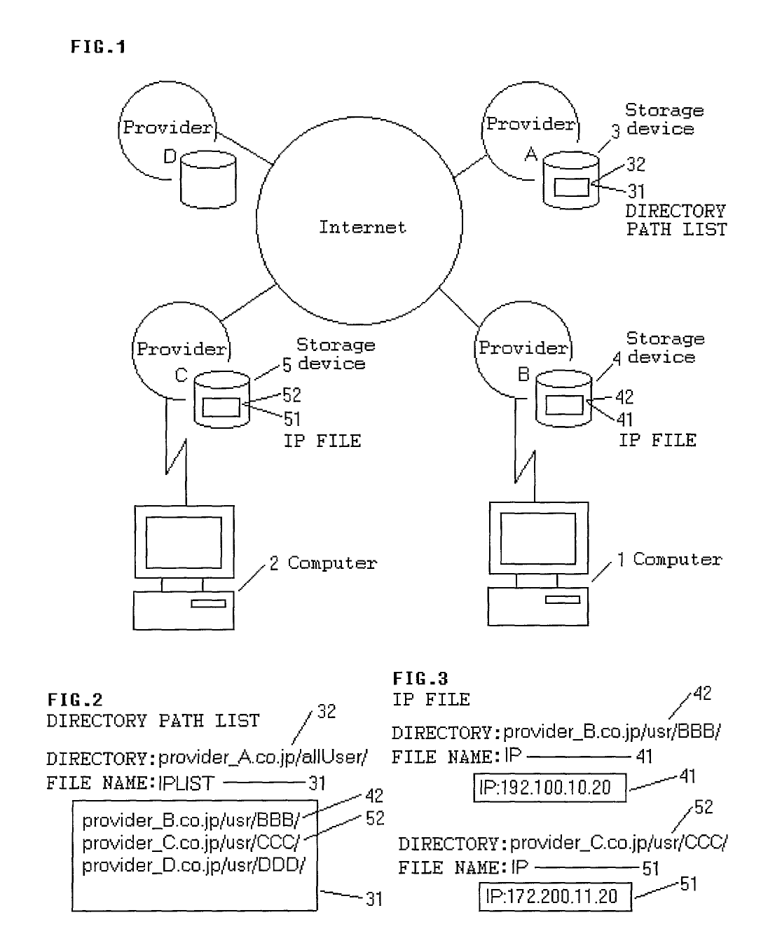

### DETAILED DESCRIPTION OF THE INVENTION

Case of internet;

Previously, store the file of DIRECTORY PATH LIST(31) named IPLIST on the storage device(3) in the computer of internet provider-A, that DIRECTORY PATH LIST(31) includes URL(Universal Resource Locator) and directory path name(42,52) where each computer store the IP FILE(41,51) that connecting with internet.

Input the file name of DIRECTORY PATH LIST(31) and IP FILE(41,51), and input the URL and directory path name(32) of DIRECTORY PATH LIST(31) to the program used this invention.

DIRECTORY PATH LIST(31) and IP FILE(41,51) are permitted to read from each computer(1,2).

And IP FILE(41,51) are permitted to write for each computer(1,2) by means of sharing storage for own computer by provider.

Start the program that used this invention.

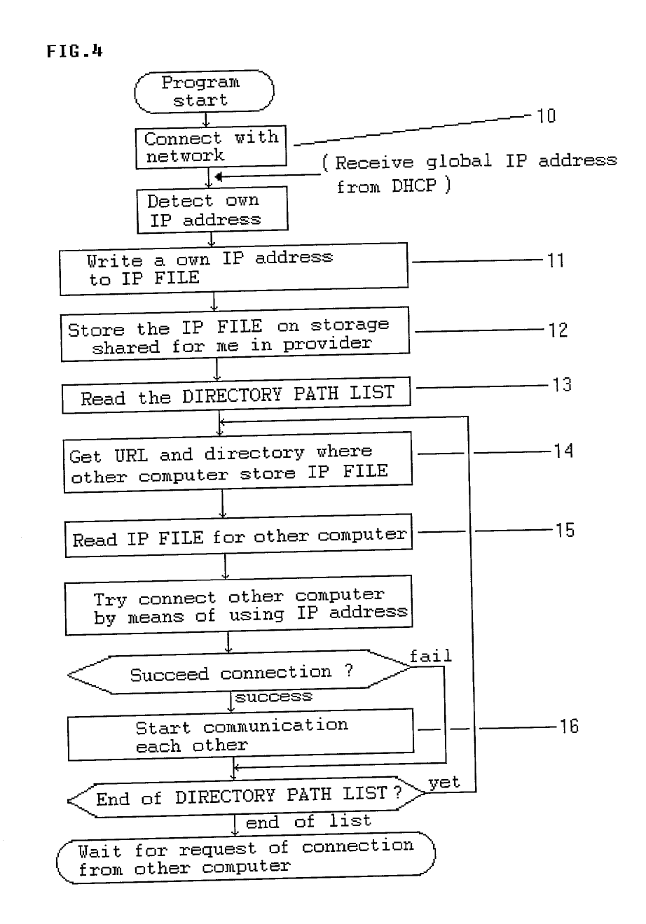

When this program(FIG. 4) connect(10) with the computer of internet provider, this program write(11) a own global IP address to IP FILE and store(12) the IP FILE on the storage device in the computer of internet provider by means of useing FTP(File Transfer Protocol).

Global IP address is received from DHCP server in the internet provider.

URL and directory path where store IP FILE(41,51) is same directory that registerd for own in the DIRECTORY PATH LIST(31).

This program(FIG. 4) read(13) the DIRECTORY PATH LIST(31), and get(14) the URL and directory path name where each computer srore the IP FILE.

This program read(15) the IP FILE(41,51) of other computer from URL and directory path(42,52) that is got by means of reading DIRECTORY PATH LIST(31).

This program get global IP address of other computer by means of reading IP FILE(41,51).

This program is able to communicate(16) with other computer via internet by means of useing global IP address.

I claim:

1. Method of communication used IP address by means of to fix a directory of IP address, even if IP address is not fixed in the network;
previously, store a file of DIRECTORY PATH LIST in the storage device;
the DIRECTORY PATH LIST includes directory path name to store the IP FILE for each computer connecting with network;
IP FILE is file in the strage device and includes IP(Internet Protocol) address of the computer that is connecting with network;
the DIRECTORY PATH LIST and IP FILE is permitted to read by each computer;
when the program start that used this invention, this program write own IP address to IP FILE, and store the IP FILE on same directory path that registered for own in the DIRECTORY PATH LIST;
next, this program get the directory path name where other computer store the IP FILE by means of reading DIRECTORY PATH LIST;
and this program read the IP FILE that other computer stored, and try connection oter computer by means of using IP address what get from the IP FILE;
similarly, be able to imform own IP address to other computer that running this program;
if connection succeed, this program is able to communicate with other computer that running this program;
finally, even if both the computers don't have a fixed IP address because that receive IP address from DHCP(Dynamic Host Configuration Protocol) server, be able to communicate with other computer in the network without lobby server by means of to use this program using this invention;
the above method.
